(19) United States
(12) Patent Application Publication
(10) Pub. No.: US 2007/0215759 A1
(43) Pub. Date: Sep. 20, 2007

(54) DEVICE FOR ORGANIZING SLACK IN MEDICAL TUBING

(76) Inventors: Roger W. Heegaard, Minneapolis, MN (US); Ernest Ruiz, Richfield, MN (US); James G. Skakoon, Saint Paul, MN (US); John K. Lampe, Saint Paul, MN (US)

Correspondence Address: SHERRILL LAW OFFICES, 4756 BANNING AVE, SUITE 212, WHITE BEAR LAKE, MN, 55110-3205, US

(21) Appl. No.: 11/688,032

(22) Filed: Mar. 19, 2007

Related U.S. Application Data
(60) Provisional application No. 60/783,276, filed on Mar. 17, 2006.

(51) Int. Cl. B05B 15/06

(52) U.S. Cl. 248/90

(57) ABSTRACT

A device for organizing slack in a flexible line comprising a unitary element with clips formed in the top and bottom of the element for releasably retaining a flexible line at a point intermediate the ends of the line in the absence of an inwardly pinching bias. The device preferably has a saddle curved first major surface.

This application claims the benefit of U.S. Provisional Application No. 60/783,276, filed Mar. 17, 2006.

### BACKGROUND OF THE INVENTION

Intravenous tubing (“IV tubing”) is used in conducting intravenous therapy. Intravenous therapy is a method for administering fluids or medications directly into the venous system, usually into a patient's vein. Oftentimes the tubing will connect an IV bag containing the fluids with a catheter that introduces the fluids into the vein.

One of the problems encountered in medicine, for example, in hospitals, is keeping track of IV tubing. Oftentimes, the tubing becomes tangled, especially when multiple lines of IV tubing are used. Tangled and mixed-mixed up IV tubing can become an inconvenience and even a hazard.

The prior art contains a number of examples of IV tubing organizers. U.S. Pat. No. 5,316,246 to Scott et al., describes an intravenous tube holder with a plurality of clips that could hold a length of the tubing. U.S. Pat. No. 5,226,892 to Boswell describes a surgical tubing clamp. Many other patents describe other kinds of IV tubing organizers.

The prior art suffers from certain shortcomings or limitations. The purpose of the present invention is to overcome the shortcomings or limitations in the prior art.

### SUMMARY OF THE INVENTION

A first aspect of the invention is a device for organizing slack in a flexible line. A first embodiment of the first aspect of the invention is a unitary element with clips formed in the top and bottom of the element for releasably retaining a flexible line at a point intermediate the ends of the line in the absence of an inwardly pinching bias.

A second embodiment of the first aspect of the invention is a unitary element having (i) clips formed in the top and bottom of the element for releasably retaining a flexible line at a point intermediate the ends of the line, and (ii) a saddle curved first major surface.

A second aspect of the invention is a method of organizing slack in a flexible line. The method includes the steps of (i) obtaining a unitary element having clips formed in the top and bottom of the element capable of releasable securement of the element to the flexible line, (ii) obtaining a flexible line having ends, (iii) inserting the line into one of the clips at a point intermediate the ends of the line, wrapping the line around the element, and (iv) inserting the line into the other clip so as to prevent unraveling of the wrapped length of line.

### BRIEF DESCRIPTION OF THE DRAWINGS

FIG. 1 is a perspective view of one embodiment of the invention with tubing wrapped around and secured to both ends of the device.

FIG. 2 is a front view of the invention shown in FIG. 1 without the tubing.

FIG. 3 is a top view of the invention shown in FIG. 1 without the tubing.

FIG. 4 is a side view of the invention shown in FIG. 1 without the tubing.

FIG. 5 is a perspective view of the invention shown in FIG. 1 with the tubing detached from one end and unwrapped from around the device.

FIG. 6 is a perspective view of a second embodiment of the invention.

FIG. 7 is a top view of the invention shown in FIG. 6.

FIG. 8 is a front perspective view of a third embodiment of the invention.

FIG. 9 is an upper rear perspective view of the invention shown in FIG. 8.

FIG. 10 is a right side view of the invention shown in FIG. 8.

FIG. 11 is a left side view of the invention shown in FIG. 8.

FIG. 12 is a top view of the invention shown in FIG. 8.

FIG. 13 is a bottom view of the invention shown in FIG. 8.

FIG. 14 is a front view of the invention shown in FIG. 8.

FIG. 15 is a back view of the invention shown in FIG. 8.

### DETAILED DESCRIPTION OF THE INVENTION

Nomenclature

100 Device (First Embodiment)
101 Backing
102a First Ridge
102b Second Ridge
102c Third Ridge
102d Fourth Ridge
102e Fifth Ridge
102f Sixth Ridge
102g Seventh Ridge
102h Eighth Ridge
102i Ninth Ridge
102j Tenth Ridge
103a First Clip
103b Second Clip
104 Tubing
104a First End of Tubing
104b Second End of Tubing
105a Top of Device
105b Bottom of Device
105c Right Side of Device
105d Left Side of Device
106 Narrowed Portion of Clips
107 Widened Portion of Clips
108 Inwardly Projecting Tabs on Clips
200 Device (Second Embodiment)
201 Backing
202a First Rib
202b Second Rib
203a First Clip
203b Second Clip
205a Top of Device
205b Bottom of Device
206 Narrowed Portion of Clips
207 Widened Portion of Clips
300 Device (Third Embodiment)
301 First Major Surface of Device
302 Second Major Surface of Device
303a First Clip
303b Second Clip
305a Top of Device
305b Bottom of Device
305c Right Side of Device
305d Left Side of Device
308 Inwardly Projecting Tabs on Clips
Long Longitudinal Center Line
Lat Lateral Center Line
x Longitudinal Direction
y Lateral Direction
z Transverse Direction
   Definitions

As utilized herein, including the claims, the term “saddle curve” means a surface defining a convex curve in a first direction and a concave curve in second direction which is substantially orthogonal to the first direction.

As utilized herein, including the claims, the phrases “substantially orthogonal” and “substantially perpendicular” mean positioned relative to one another at an angle of between 60° to 900.

As utilized herein, including the claims, the term “unitary” means formed from a single mass of material.

### Construction and Use of Specific Embodiments

As disclosed, the invention is generally directed to a device for organizing IV tubing. However, the invention is not limited to such uses. The structure of the device may be useful for other purposes. Other purposes might include the wrapping of cords, ropes, or any other use where a wrapping device might be usable and beneficial.

### First Embodiment

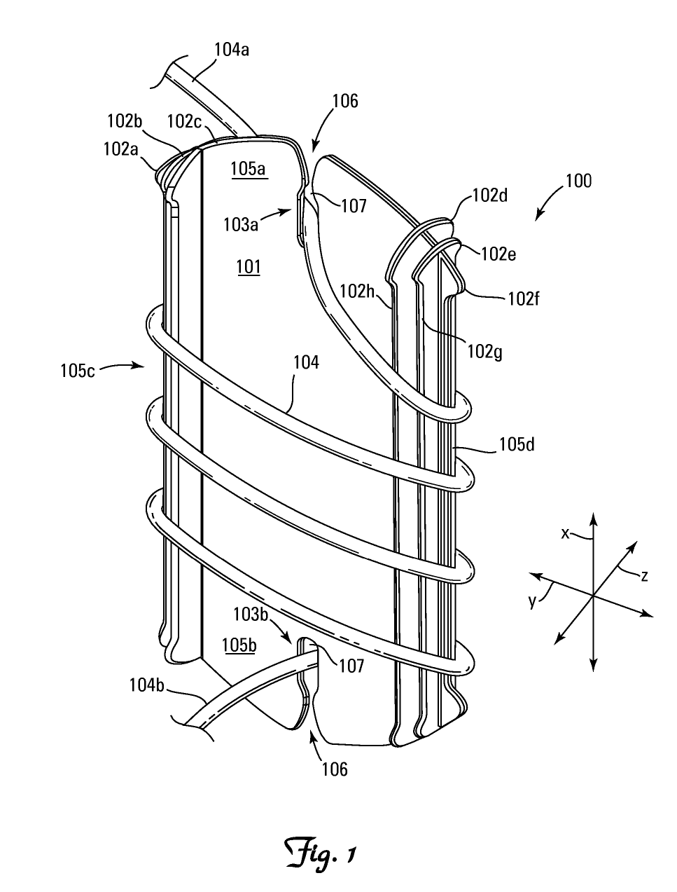

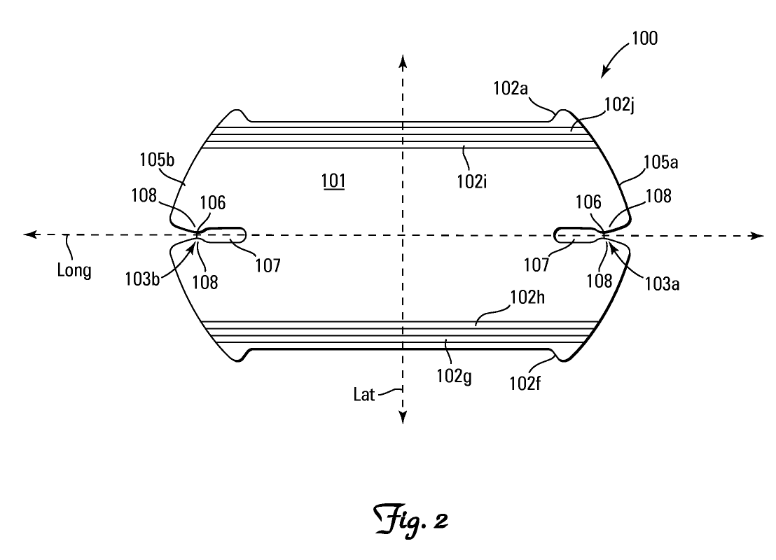

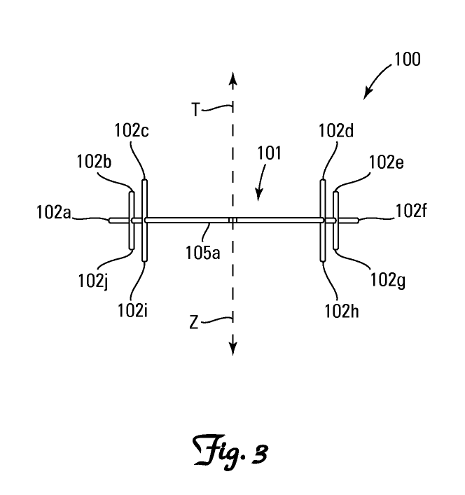

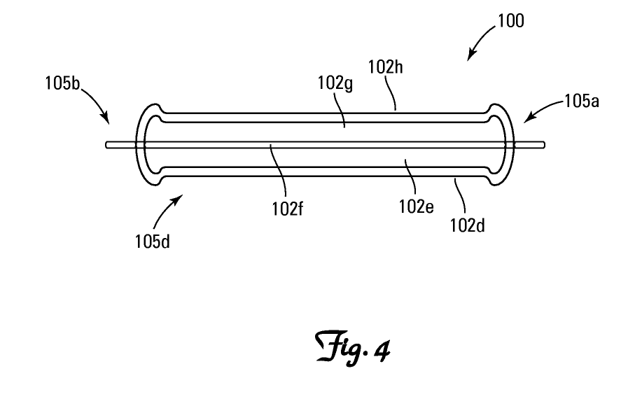

The IV tubing organizer 100 shown in FIGS. 1 to 4 can be oriented with a longitudinal centerline Long generally bisecting the organizer 100. The term longitudinal refers to a line, axis, or direction in the plane of the organizer 100 that runs parallel with the longitudinal centerline Long. The IV tubing organizer 100 shown in FIG. 1 can further be oriented with transverse T and lateral Lat centerlines orthogonal to the longitudinal centerline Long.

The length of the organizer 100 is the maximum dimension measured parallel to the longitudinal centerline Long in the longitudinal direction x. The width of the organizer 100 is the maximum dimension measured parallel to the lateral centerline Lat in the lateral direction y. The thickness of the organizer 100 is the maximum z direction dimension measured parallel to the z axis.

When a range or interval is disclosed, the disclosure is intended to disclose both the endpoints and the intervals within the range. For example, a range of 0.005 to 0.010 includes 0.005, 0.006 and 0.010 within that range.

FIGS. 1 to 4 show an IV tubing organizer 100 according to a first embodiment of the invention. The IV tubing organizer 100 can comprise backing 101, ridges 102a to 102j, and clips 103a, 103b.

On a first end 105a of the organizer 100, a user can insert the tubing 104 into the first clip 103a. The user can then wrap the desired amount of tubing 104 around the backing 101 and over the ridges 102a to 102j as shown in FIG. 1. Once having wrapped the tubing 104, the user can insert the tubing 104 in the second clip 103b on the second end 105b.

The clips 103a, 103b can hold the tubing 104 in place on the IV tubing organizer 100. The narrowing 106 in the clips 103a, 103b can be of a width that holds the tubing 104, under normal use within the widening 107. For many kinds of IV tubing, a width of 0.05 inches for the narrowing 106 can be suitable to maintain the tubing 104 within the widening 107 during normal use.

Each clip 103a and 103b preferably includes a set of transversely z flexible, inwardly projecting tabs 108 for facilitating retention of tubing 104 placed within the clip 103a and 103b.

The IV tubing organizer 100 can be made of various materials including preferably plastics capable of being injection molded. However, various other materials including other plastics, foam, metal, ceramic, glass, cellulose-based materials can also be suitable.

The IV tubing organizer 100 has several advantageous features. First, the IV tubing organizer 100 can help caregivers organize IV tubing 104. For a typical set-up, a first end 104a of the IV tubing 104 leads to the IV bag (not shown). The second end 104b leads to the catheter (not shown). The IV tubing 104 needs to be long enough to allow the patient (not shown) to move relatively freely. On the other hand, in many instances, the IV tubing 104 can drag on the floor or hook on objects (not shown). This can yank the IV tubing 104 and can result in the catheter (not shown) being pulled from the patient (not shown). By taking up excess slack in the tubing 104, the IV tubing organizer 100 can help manage excess tubing 104.

Second, the clips 103a, 103b can release the IV tubing 104 when the tubing 104 is strained. The material of the backing 101 near the narrowing 106 can be sufficiently flexible to bend when the tubing 104 is yanked. In addition the tubing 104 will have some give and can be pulled through the narrowing 106 when sufficient force is exerted on the tubing 104.

In the manufacturing process the desirable size of narrowing 106 (or channel) can be created depending on the particular application. For many applications it can be desirable to have a narrowing 106 of a size that retains the tubing 104 in the widening 107 when no significant strain is put on the tubing 104. For example, it may be desirable to have the narrowing 106 have a width that prevents release of the tubing 104 from the organizer 100 when gravity exerts pulling force on the tubing 104 retained by the organizer 100. This can prevent premature release of the tubing 104 when no pulling forces (other than gravity) are exerted on the IV tubing 104 held by the organizer 100.

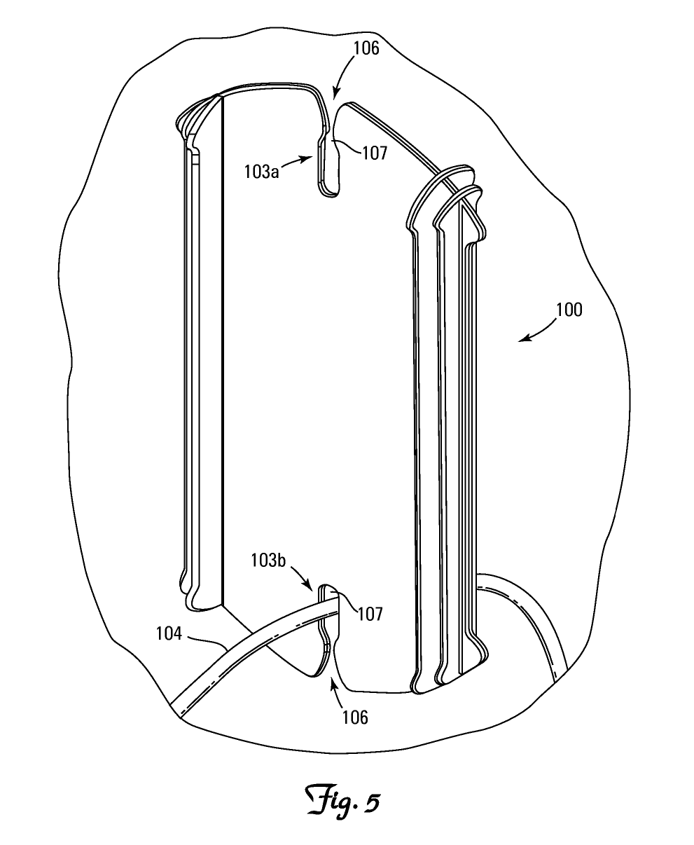

The actual force that is exerted by gravity (and other forces) on tubing 104 held by the organizer 100 can be dependent on many things—for example, how many times the tubing 104 is wrapped around the organizer 100, the position of the organizer 100 in space, the kind of tubing 104 in use, the position on the tubing 104 within the clips 103a, 103b, elevation at which the tubing 104 is used, etc. A typical level of force that can be exerted by gravity on tubing 104 held by the organizer 100 can be present when the tubing 104 is not wrapped around the organizer 100 but is simply held in one of the clips 103b with the length of the organizer 100 parallel to the force of gravity as shown in FIG. 5. This can be identified as a “test release position.” Disregarding the IV bag (not shown), a typical length of IV tubing 104 that is approximately 4 millimeters in diameter and includes various attachments such as a drip chamber (not shown) might weigh approximately 0.10 lbs when empty and approximately 0.15 lbs when filled with a liquid. Therefore in order to retain in the clip 103b such a length of tubing 104 filled with a liquid, the narrowing 106 can be of a width that resists at least 0.15 lbs of force (i.e., the force of gravity identified in this example) for that size and type of tubing 104.

For most applications, it may be preferable to have a clip 103b that retains the tubing 104 when subjected to forces greater than gravity, e.g., if a catheter is inserted in the arm, when the arm moves and strains the length of tubing 104. Such a force on the tubing 104 might be comparable to a 2 lbs force measured in the “test release position.” In order to allow for release in such cases it might be preferable to have a clip that releases within a range of 1.5 to 2 lbs of force.

For other applications, it may be desirable to have a clip 103b that releases when subjected to a different level of force. To ensure easier release, it might be preferable to have a clip 103b that releases in the “test release position” in a range of 0.10 to 1.0 lbs of force. For more retention, it might be preferable to have a clip 103b that releases in a range of 1.0 to 2.0 lbs of force. For even greater retention it might be preferable to have a clip 103b that releases in the range of 2.0 to 3.0 lbs of force, or a range of 3.00 to 4.0 lbs. or a range of 4.0 to 5.0 lbs. The clip 103b can be manufactured to release at forces greater than or less than those specified here. However, for many applications, the ranges specified here can be suitable.

Other configurations of the clips 103a, 103b are also possible. For example, one clip 103b might have a narrowing 106 of a different width than the other clip 103a. This can allow, for example, one clip 103b to release easier than the other clip 103a. This can ensure easy release of one clip 103b, thereby allowing any wrapped tubing 104 to unwind (not shown), but the organizer 100 can still remain attached to the tubing 104 by the other clip 103a.

In addition, different kinds of retainers (not shown) other than the clips 103a, 103b discussed in relation to FIGS. 1 to 5 can be suitable. Those other retainers such as clamps, releasable adhesive bonds, hook and loop attachments, etc. (not shown), can be configured to release the tubing 104 within the desirable release range.

Finally, the discussion above concerns one example of tubing 104. Other kinds of tubing 104 or other kinds of lines can have different weights and thicknesses. For other kinds of tubing 104 or lines, different ranges of pulling forces can be desirable. An organizer 100 that has clips 103a, 103b that retain the tubing 104 or lines within those different ranges can still be within the scope of this invention.

Third, the clips 103a, 103b can secure the tubing 104 without crimping the tubing 104. The narrowing 106 in the clips 103a, 103b holds the tubing 104 within the widening during normal use. The widening 107 in the clips 103a, 103b can be sufficient to minimize pressure on the tubing 104.

Fourth, the ridges 102a to 102j also help secure the tubing 104 without crimping. The ridges 102a to 102j help ensure the wrapped tubing 104 can maintain a sufficiently wide radius around the sides 105c, 105d to prevent crimping.

### Second Embodiment

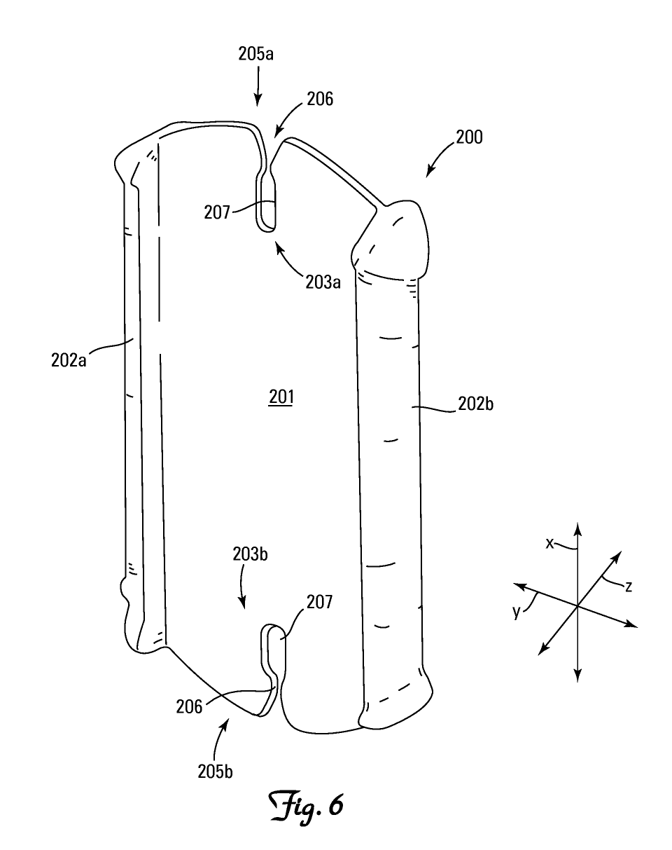

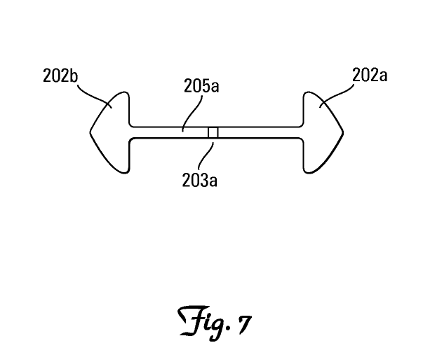

FIGS. 6 and 7 show a IV tubing organizer 200 according to a second embodiment. The IV tubing organizer 200 can resemble the IV tubing organizer 100 according to the first embodiment shown in relation to FIGS. 1 to 4.

The IV tubing organizer 200 has a top 205a and a bottom 205b with clips 203a and 203b provided therein. The clips 203a and 203b each have a narrowed portion 206 and a widened portion 207. The organizer 200 has rounded side ribs 202a and 202b as shown in FIGS. 6 and 7. The rounded side ribs 202a and 202b can take the place of the ridges 102a to 102j shown in relation to FIGS. 1 to 4.

The IV tubing organizer 200 can preferably be made of materials such as foam. The foam can be relatively stiff, allowing the IV tubing organizer 200 to maintain its shape under normal use. However, the materials described above in relation to the first embodiment or other materials can also be suitable.

### Third Embodiment

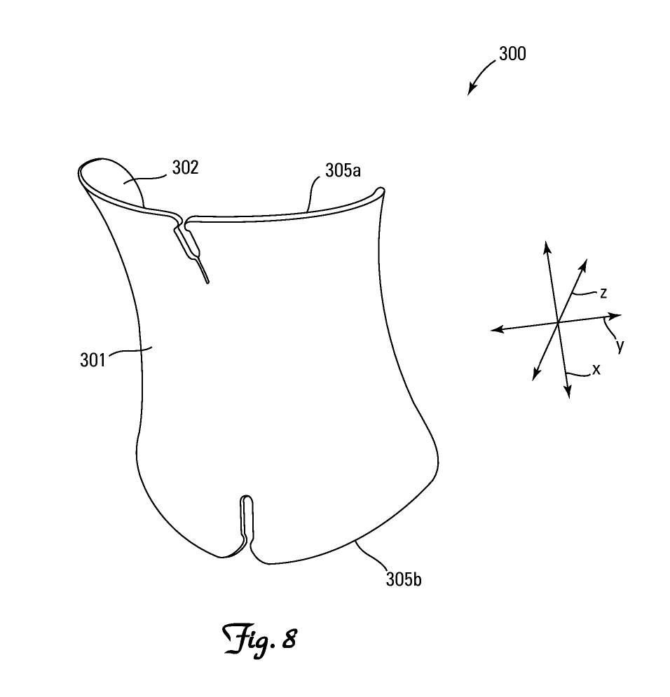

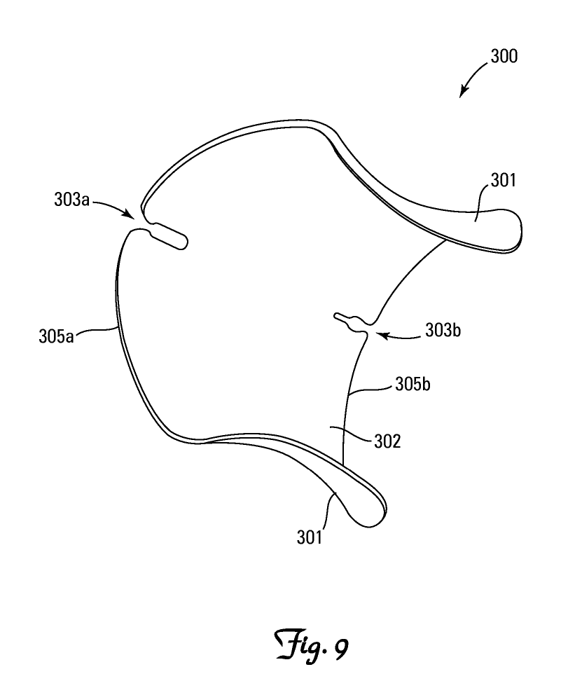

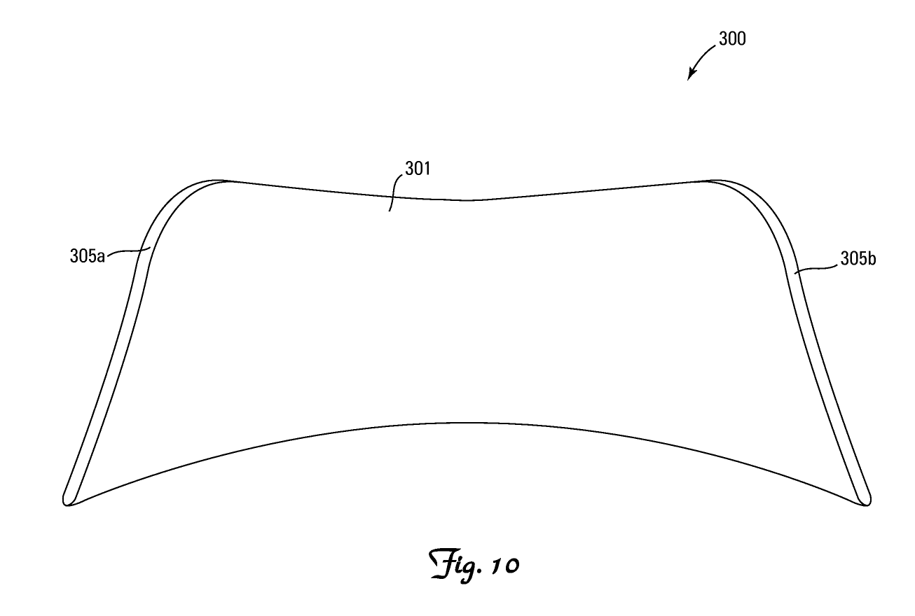

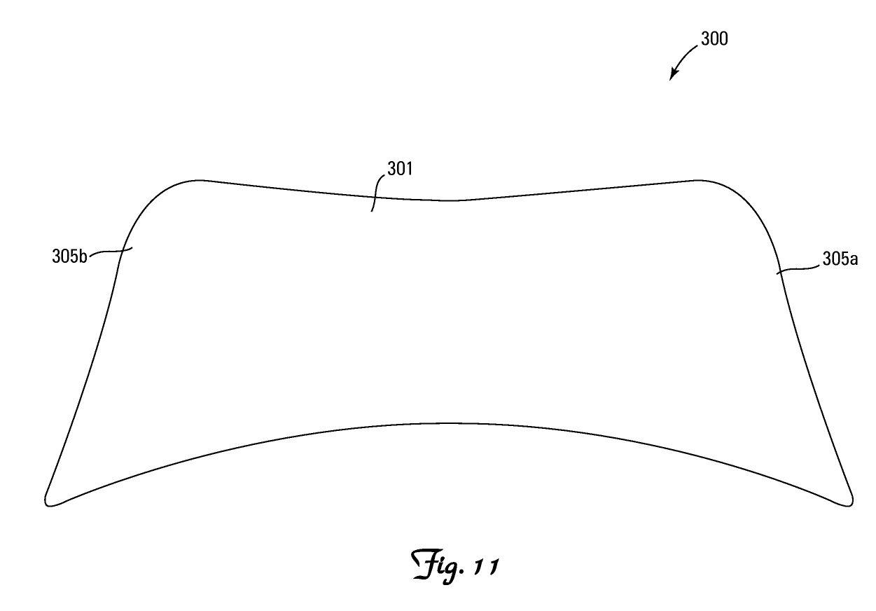

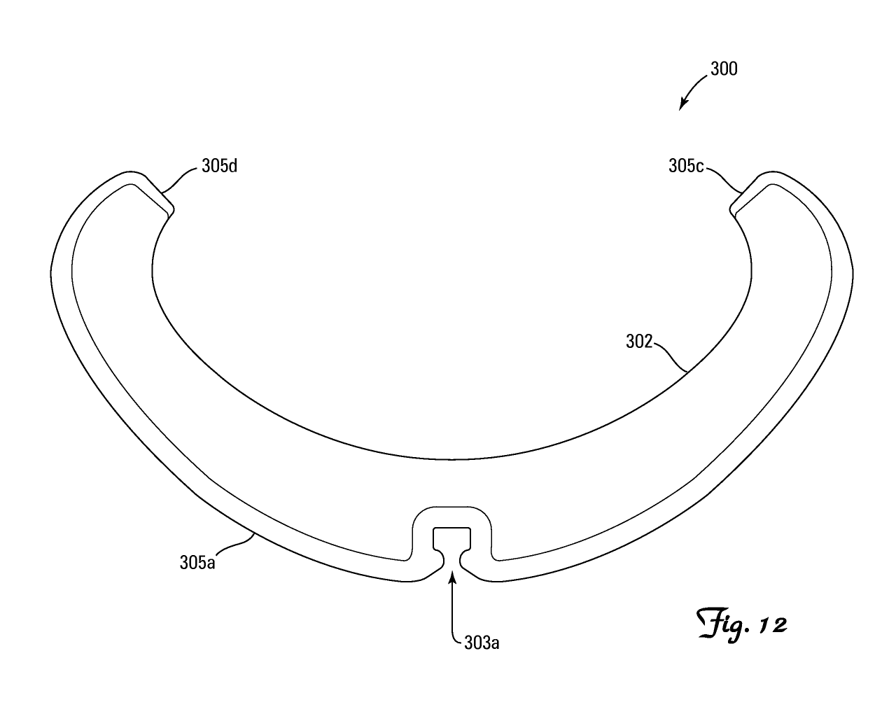

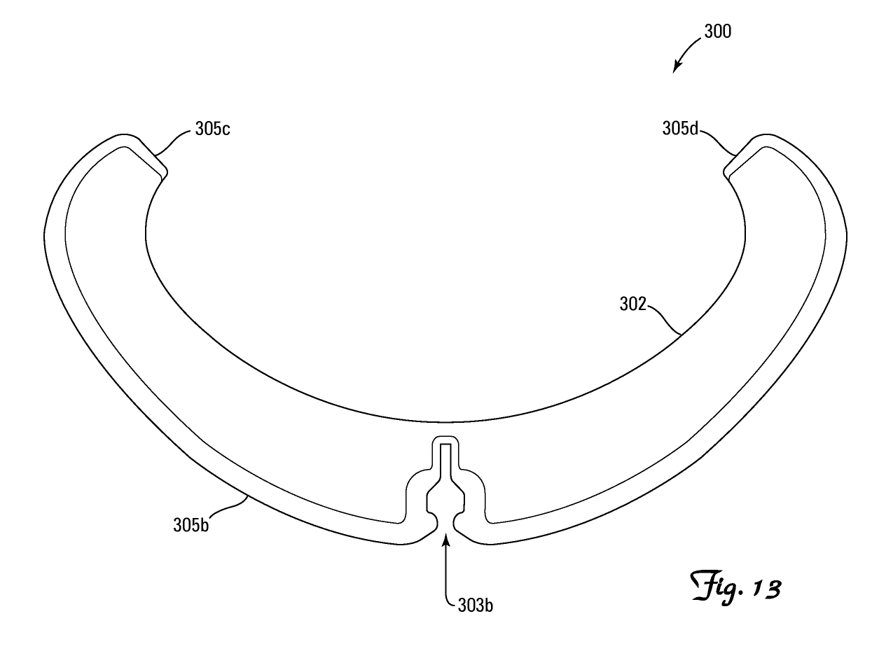

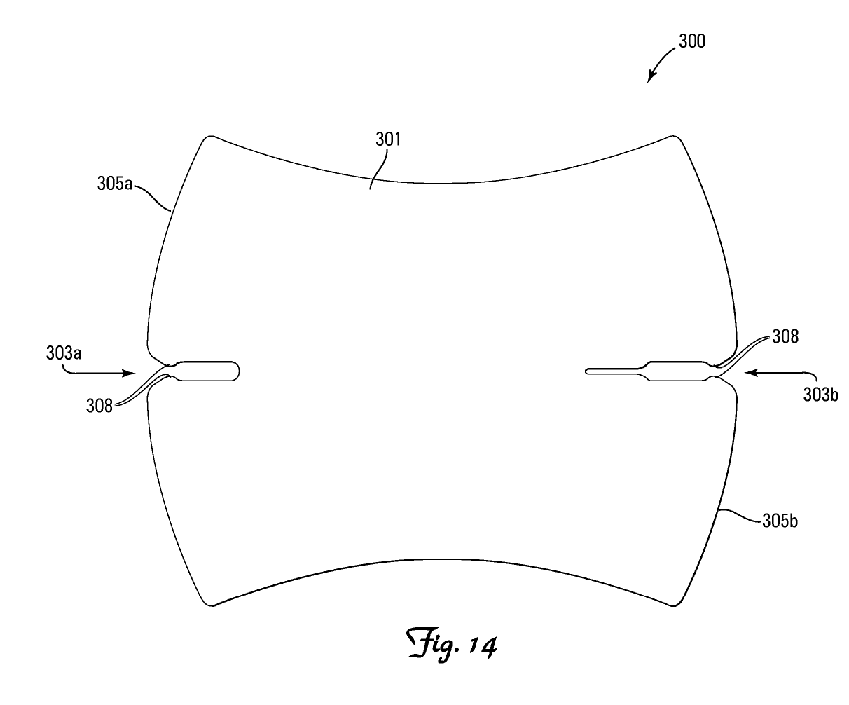

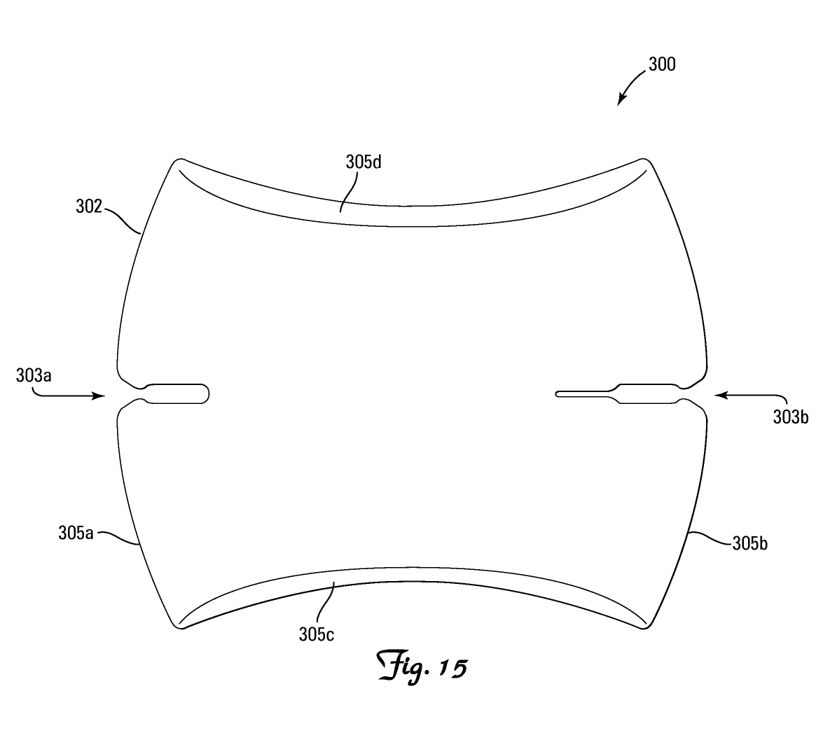

A third embodiment of the device 300 is shown in FIGS. 8-15. The device 300 has a top 305a, bottom 305b, a right side 305c, and a left side 305d, with a first major surface 301 and a second major surface 302.

Tube retention clips 303a and 303b are formed at the top 305a and bottom 305b of the device 300 respectively. Each clip 303a and 303b preferably includes a set of transversely z flexible, inwardly projecting tabs 308 for facilitating retention of tubing 104 placed within the clip 303a and 303b. The lateral y width of the clips 303a and 303b may be the same or different.

The first major surface 301 is configured and arranged with a saddle curve wherein the first major surface 301 forms a concave curve along the longitudinal center line Long of the device 300, and a convex curve along the lateral center line Lat of the device 300. The saddle curve provides a smooth lateral y line of curvature and a longitudinal x inward bias to tubing 104 laterally y wrapped around the device 300.

The second major surface 302 is preferably configured and arranged to mimic the saddle curve of the first major surface 301, with a concave curve formed along the longitudinal center line Long of the device 300, and a convex curve formed along the lateral center line Lat of the device 300.

The radius of curvature about a longitudinal x axis is preferably decreased proximate the right 305c and left 305d sides of the device 300 so that tubing 104 wrapped around the device 300 does not contact the right 305c and left 305d edges, thereby further reducing the likelihood of kinking tubing 104 wrapped around the device 300.

Modifications

The present invention should not be considered limited to the particular examples described above, but rather should be understood to cover all aspects of the invention as fairly set out in the claims arising from this application. For example, while suitable sizes, materials and arrangement of the elements have been disclosed in the above discussion, it should be appreciated that these are provided by way of example and not of limitation as to the size, material and arrangement of the elements. Various modifications, as well as numerous structures within the scope of the invention, will be readily apparent to those of skill in the art upon review of the present specifications. The claims which arise from this application are intended to cover such modifications and structures.

We claim:

1. A device for organizing slack in a flexible line, comprising a unitary element having clips formed in the top and bottom of the element for releasably retaining a flexible line at a point intermediate the ends of the line in the absence of an inwardly pinching bias.

2. A device for organizing slack in a flexible line, comprising a unitary element having (i) clips formed in the top and bottom of the element for releasably retaining a flexible line at a point intermediate the ends of the line, and (ii) a saddle curved first major surface.

3. The device of claim 1 wherein the flexible line is flexible medical tubing.

4. The device of claim 2 wherein the flexible line is flexible medical tubing.

5. A method of organizing slack in a flexible line, comprising the steps of:
(a) obtaining a unitary element having clips formed in the top and bottom of the element capable of releasable securement of the element to the flexible line,
(b) obtaining a flexible line having ends,
(c) inserting the line into one of the clips at a point intermediate the ends of the line,
(d) wrapping the line around the element, and
(e) inserting the line into the other clip so as to prevent unraveling of the wrapped length of line.

6. The method of claim 5 wherein the device has a saddle curved first major surface.

7. The method of claim 5 wherein the flexible line is flexible medical tubing.

8. The method of claim 7 wherein the medical tubing is in fluid communication with a human.
